(19) United States
(12) Patent Application Publication
(10) Pub. No.: US 2012/0100289 A1
(43) Pub. Date: Apr. 26, 2012

(54) INSULATING COMPOSITIONS COMPRISING EXPANDED PARTICLES AND METHODS FOR APPLICATION AND USE

(75) Inventors: Luke S. Egan, Rock Hill, SC (US); Michael Guibault, Fort Mill, SC (US); Robert Michael Calhoun, Charlotte, NC (US); Michael Drewery, Monroe, NC (US); Colby Swanson, Jersey City, NJ (US); Michael McNulty, Charlotte, NC (US); Thomas Meyer, Lake Mills, WI (US); Richard Aaron Davenport, Fort Mill, SC (US)

(73) Assignee: BASF SE, Rheinland-Pfalz (DE)

(21) Appl. No.: 13/248,368

(22) Filed: Sep. 29, 2011

Related U.S. Application Data
(60) Provisional application No. 61/387,778, filed on Sep. 29, 2010.

(51) Int. Cl. E04B 1/78; B05D 1/34; B05B 9/01

(52) U.S. Cl. 427/196; 252/62; 118/311; 427/426

(57) ABSTRACT

Compositions and methods for their application are described herein. The compositions include a plurality of particles having a density of 1000 kg/m³ or less (e.g., a pre-expanded polymer) and a binder. Also described herein is a method of applying the composition onto a surface. The method includes blowing a plurality of particles having a density of 1000 kg/m³ or less in at least one first stream and spraying a binder in at least one second stream onto a surface. Further provided is an apparatus for spraying the composition.

### CROSS-REFERENCE TO RELATED APPLICATION

This application claims priority to U.S. Provisional Application No. 61/387,778, filed Sep. 29, 2010, which is incorporated herein by reference in its entirety.

### BACKGROUND

Air barriers are often used in construction applications to prevent air from leaking into and out of the building enclosures. Air barriers can be applied as liquid compositions that either include curing agents or require external forces (e.g., heat) to effect foam gelation in the barrier. The process of applying air barriers of this type can be difficult, often requiring blowing agents for foam expansion, coagulants, long drying times, and tedious techniques to apply the composition.

### SUMMARY

Compositions comprising expanded foam and methods for their application are described herein. The compositions include a plurality of particles having a density of 1000 kg/m³ or less (e.g., 500 kg/m³ or less, less than 300 kg/m³, less than 100 kg/m³, or from 10 kg/m³ to 50 kg/m³) and a binder (e.g., an adhesive). In some examples, the plurality of particles comprises greater than 80% by volume of the composition (e.g., greater than 85% by volume of the composition or greater than 90% by volume of the composition).

The plurality of particles as described herein can be pre-expanded polymers that can be fully expanded or partially expanded, for example, with air. For example, the pre-expanded polymer can be comprised of from 50% to 99% air by volume. The pre-expanded expanded polymer can be selected from the group consisting of polystyrene, styrene-based-copolymers, polyethylene, polypropylene, polyesters, polyvinylchloride, cellulose acetate, and mixtures thereof. In some examples, the pre-expanded polymer can include poly(styrene-co-acrylonitrile).

The plurality of particles can include, for example, beads, flakes, granules, fibers, platelets, spheres, microballoons, or a mixture thereof. The average particle size of the largest dimension of the plurality of particles can be from 0.1 to 1000 mm. In some examples, the plurality of particles includes inorganic particles. The plurality of particles can be flame retardant. The plurality of particles can further include recycled material.

The binder of the composition can have a solids percentage from 20% to 85%. The binder can include a polymer, for example, selected from the group consisting of acrylic-based polymers or copolymers, styrene-acrylic-based copolymers, styrene-butadiene-based copolymers, vinyl acrylic-based copolymers, vinyl acetate based polymers or copolymers, polyvinylidene chloride, neoprene, natural rubber latex, and mixtures thereof. When dried, the binder can be moisture vapor permeable. In some examples, the binder includes a self-crosslinking polymer or a crosslinkable polymer. The binder can further include a crosslinking agent (e.g., a metal salt of an organic acid). In some examples, the binder is flame retardant.

In some examples, the composition is substantially free of curing agents or crosslinking agents. When dried, the composition can have an R value of from 0.1 per inch to 6 per inch. The composition can be moisture vapor permeable (independent of the binder). The composition can further include a filler such as a heat reflective material (e.g., a pigment).

Also described herein are methods of applying a composition onto a surface. The method can include combining a plurality of particles having a density of 1000 kg/m³ or less and a binder to form a composition wherein the plurality of particles comprise greater than 80% by volume of the composition and applying the composition onto a surface. Alternatively, the method can include blowing a plurality of particles having a density of 1000 kg/m³ or less in at least one first stream and spraying a binder in at least one second stream onto a surface. In some examples, the at least one second stream further comprises a plurality of particles having a density of 1000 kg/m³ or less. In some examples, the binder is sprayed in more than one second stream onto the surface. The surface can be, for example, within a cavity. In some examples, the at least one first stream and the at least one second stream are combined outside of an apparatus for applying the composition onto a surface and prior to reaching the surface. In other examples, the at least one first stream and the at least one second stream can be combined within an apparatus for applying the composition onto a surface. The composition can be applied to an existing insulating layer or into a cavity or crevice.

Further provided is an apparatus for spraying the composition onto a surface. The apparatus includes a first chamber comprising the plurality of particles having a density of 1000 kg/m³ or less, a second chamber comprising the binder, and a multicomponent nozzle for applying the plurality of particles and the binder to a surface. In some examples, the second chamber further comprises a plurality of particles having a density of 1000 kg/m³ or less. The apparatus is adjustable such that the amount of the pre-expanded polymer that exits the nozzle can vary from 0% to 100% of the total composition and the amount of the adhesive that exits the nozzle can vary from 0% to 100% of the total composition.

The details of one or more embodiments are set forth in the description below and in the drawing. Other features, objects, and advantages will be apparent from the description, the drawing and from the claims.

### BRIEF DESCRIPTION OF THE DRAWING

FIG. 1 illustrates an apparatus for applying the compositions described herein.

### DETAILED DESCRIPTION

Compositions, methods for applying these compositions, and apparatuses for applying these compositions are described herein. The compositions include a plurality of particles and a binder. The plurality of particles has a density of 1000 kg/m³ or less. For example, the plurality of particles can have a density of 500 kg/m³ or less, 400 kg/m³ or less, 300 kg/m³ or less, 200 kg/m³ or less, 100 kg/m³ or less, 50 kg/m³ or less, or 25 kg/m³ or less, or 20 kg/m³ or less. In some examples, the plurality of particles can have a density of from 10 kg/m³ to 50 kg/m³ (e.g., from 10 kg/m³ to 20 kg/m³). The plurality of particles can include polymeric particles, non-polymeric particles, and mixtures of these, including, for example, inorganic microspheres and lightweight inorganic particles (e.g., inorganic particles with a density from 10 kg/m³ to 20 kg/m³).

In some examples, the plurality of particles includes pre-expanded polymers. The pre-expanded polymer can be previously expanded through the use of an organic blowing agent (e.g., a hydrocarbon such as pentane, isopentane, butane, or mixtures of these) or an inorganic blowing agent (e.g., air, carbon dioxide, nitrogen, argon, or mixtures of these) to provide a particle having a larger size but a lower density. For example, the pre-expanded polymer can be comprised of from 1% to 99%, 25% to 95% or 50% to 90% air by volume. The pre-expanded polymer described herein can be partially expanded (i.e., capable of further expansion) or fully expanded. For example, the polymer can be greater than 50% expanded, greater than 60% expanded, greater than 70% expanded, greater than 80% expanded, greater than 90% expanded or 100% (i.e., fully) expanded as determined based on the density of the polymer.

The pre-expanded polymer described herein can be derived from expandable polymers, including, for example, thermoplastic polymers. Examples of pre-expanded polymers include polystyrene (e.g. free-radical-polymerized glass-clear polystyrene (GPPS) or anionically polymerized polystyrene (APS)), styrene-based-copolymers (e.g., styrene-maleic anhydride copolymers, styrene-butadiene copolymers, styrene-α-methylstyrene copolymers, acrylonitrile-butadiene-styrene (ABS) copolymers, styrene-acrylonitrile (SAN) copolymers, styrene-methyl methacrylate copolymers, acrylonitrile-styrene-acrylate (ASA) copolymers, methacrylate-butadiene-styrene (MBS) copolymers, or methyl methacrylate-acrylonitrile-butadiene-styrene (MABS) copolymers), polyethylene (e.g., low density polyethylene, high density polyethylene, and linear low-density polyethylene), polypropylene, polyesters, polyvinylchloride, cellulose acetate, copolymers of vinyl and vinylidene chloride, polyacrylic esters, polymethacrylic esters, thermoplastic polyurethane and polyamides, and mixtures of these. Further examples of suitable pre-expanded polymers include polyphenylene oxide, polystyrene-polyphenylene oxide blends, polyoxymethylene, poly(methyl methacrylate), methyl methacrylate copolymers, ethylene-propylene copolymers (e.g., random and block), ethylene-vinyl acetate copolymers, polycarbonate, polyethylene terephthalate, aromatic polyester/polyether glycol block copolymer, polyethylene and polymerized vinyl aromatic resins. Examples of vinyl aromatic resins include the solid homopolymers of styrene, vinyltoluene, vinylxylene, ethylvinylbenzene, isopropylstyrene, t-butylstyrene, chlorostyrene, dichlorostyrene, fluorostyrene, bromostyrene; the solid copolymers of two or more monovinyl aromatic compounds; and the solid copolymers of one or more of monovinyl aromatic compounds and a copolymerizable olefinic compound (e.g., acrylonitrile, methyl methacrylate, or ethyl acrylate). In some examples, the pre-expanded polymer includes a mixture of polystyrene and polyvinyl chloride. Examples of suitable commercially available pre-expanded polymers include NEOPOR and STYROPOR, expandable polystyrenes commercially available from BASF Corporation (Florham Park, N.J.); and DUALITE, a heat expandable polymeric microsphere commercially available from Henkel Corporation (Dusseldorf, Germany).

The plurality of particles can include organic particles and/or inorganic particles. In some examples, the plurality of particles includes inorganic particles. The inorganic particles can be hollow, solid, macroporous, inert, and/or non-toxic. Examples of these particles include perlite, expanded perlite, NANOGEL aerogel (Cabot Corporation; Boston, Mass.) and NOBLITE (Noble International; France).

The individual particles of the plurality of particles are not limited in shape. For example, the individual particles of the plurality of particles can be beads, flakes, fibers, rods, disks, cubes, cylinders, pyramids, cones, cuboids, spheres, granules, platelets, microballoons, or mixtures of these. In some examples, the plurality of particles is uniform in shape (e.g., beads only). In other examples, the plurality of particles includes a mixture of two or more shapes (e.g., beads, spheres, and flakes). In some embodiments, the particles of the plurality of particles are preferably small in size and of low density and overall weight. For example, the average particle size of the largest dimension of the plurality of particles is from 0.1 to 1000 mm or from 0.1 to 10 mm. The plurality of particles for use in the compositions described herein may include multiple particle sizes in the composition, i.e., two or more different particle sizes. For example, the individual particles of the plurality of particles can include a combination of two or more of small (i.e., the largest dimension of the pre-expanded polymer is less than 1.0 mm), medium (i.e., the largest dimension of the pre-expanded polymer is from 1.0 to 2.0 mm), large (i.e., the largest dimension of the pre-expanded polymer is from 2.0 mm to 10 mm) and extra-large (i.e., the largest dimension of the pre-expanded polymer is greater than 10 mm, such as, for example, from 10 mm to 1000 mm) particle sizes to provide a closely packed yet breathable barrier. The extra-large particles can particularly be based on fibers.

Further, the plurality of particles can be flame retardant either by including one or more flame retardant additives or fillers or by being flame retardant themselves. Examples of flame retardant additives or fillers suitable for inclusion in the plurality of particles include alumina trihydrate; hydrotalcite; synthetic or natural zeolites; alumina hydrates (e.g., alumina monohydrate); aluminum hydroxide; aluminum nitrate; ammonium polyphosphate; ammonium phosphate; ammonium alum; antimony oxide; decabromodiphenyloxide; potassium alum; kalimite; halogenated compounds (e.g., chlorinated waxes, brominated additives, plasticizers, and polyvinylchloride); inorganic hydroxides; barium chloride; barium peroxide; boric acid; borax; borate salts (e.g., zinc borate and calcium borate); calcium sulfate; calcium sulfite; calcium phosphate; magnesium pyrophosphate; magnesium ammonium chloride; magnesium carbonate; magnesium hydroxide; magnesium oxide; NOBLITE (Noble International; France); perlite; phosphate esters; sodium diboric phosphate; sodium tribasic phosphate; sodium meta silicate; sodium sulfate; sodium carbonate; vermiculite, zinc nitrate; hexabromocyclododecane; triallyl isocyanurate hexabromide; tetrachlorophenol; expandable graphite additives; pentaerythritols; phosphorus-based materials such as NCENDX P-30 and P-40 (commercially available from Albermarle Corporation; Baton Rouge, La.); and mixtures of these. Flame retardant particles can be organic particles or inorganic particles. An example of an inorganic flame retardant particle includes NANOGEL aerogel (Cabot Corporation; Boston, Mass.), an amorphous, non-combustible, silica composition.

The plurality of particles can include insulating materials (e.g., cellulosic materials, fiberglass, rockwool, expanded polystyrene, and polyurethane). The plurality of particles can alternatively include recycled materials and the recycled materials can be insulating materials. For example, the plurality of particles can include recycled materials such as organic materials (e.g., polymeric materials, wood-based materials, cellulosic materials, wool, and cotton), inorganic materials (e.g., stone, glass, and metals), or composite products (e.g., paper and cardboard). Organic polymers include, for example, filled and unfilled thermoset/thermoplastic polymers. Examples of filled polymers materials are reinforced reaction injection molded (RRIM) thermoset plastic materials that have an organic component comprising substantially polyurethanes; unreacted precursors of the RRIM polymer such as polyols and isocyanates; sheet molding compounds (SMC) which have an organic component comprising styrene cross-linked polyesters; uncured SMC reactants comprising styrene and unsaturated polyesters; and epoxies, phenolics, silicates, melamines, diallylphthalates, and polyimides as are typically used in reinforced plastics. Examples of useful unfilled polymer materials are reaction injection molded (RIM) plastics, such as unreinforced RIM polyurethanes and polyureas, polyethylenes, polyethylene terephthalate, polystyrenes, and scrap rubber tires that comprise filled or unfilled polymer materials. The recycled polymer materials, inorganic recycled materials, and composite recycled products typically are ground, shredded, or otherwise comminuted before inclusion in the plurality of particles and can include lightweight or foamed polymer materials such as, but not limited to, ground expanded polystyrene, polyurethane, and other lightweight materials.

The plurality of particles may further contain additives. Examples of the additives include cell-nucleating agents (e.g., talc, calcium silicate, ethylene-bis-stearic acid amide, and methacrylic acid ester copolymer), other fillers (e.g., synthetic and naturally occurring silicon dioxide), plasticizers (e.g., diisobutyl adipate, liquid paraffin, diacetylated glycerin monolaurate, and coconut oil), colorants or pigments (e.g., carbon black and graphite), char formers, intumescents, ultraviolet absorbers, and antioxidants.

The plurality of particles can comprise greater than 80% by volume of the composition. For example, the plurality of particles can comprise greater than 85%, greater than 90%, greater than 95%, greater than 97%, or greater than 99% by volume of the composition.

As described above, the compositions described herein also include a binder. The binders for use in the compositions described herein can possess adhesive properties, barrier properties, flame retardant properties, heat reflective properties, sound damping properties, or a combination of these. The binders can be prepared from aqueous dispersions that include water and a polymer. The dispersions can be anionic, cationic, or nonionic. Suitable polymers or copolymers for the binder include acrylic-based polymers and copolymers, styrene-acrylic-based copolymers, styrene-butadiene-based copolymers, vinyl acrylic-based copolymers, vinyl acetate based polymers and copolymers (e.g. ethylene vinyl acetate), natural rubber latex, neoprene, polyvinylidene chloride, and polyurethanes. In some embodiments, the binder includes an acrylic-based polymer or copolymer, a styrene-acrylic-based copolymer, a styrene-butadiene-based copolymer, a vinyl acrylic-based copolymer, a vinyl acetate based polymer or copolymer (e.g. ethylene vinyl acetate), or a mixture thereof.

The binder can be derived from one or more monomers. For example, the monomers can include vinyltoluenes (e.g., styrene); conjugated dienes (e.g., isoprene or butadiene); α,β-monoethylenically unsaturated mono- and dicarboxylic acids or anhydrides thereof (e.g., acrylic acid, methacrylic acid, crotonic acid, dimethacrylic acid, ethylacrylic acid, allylacetic acid, vinylacetic acid, maleic acid, fumaric acid, itaconic acid, mesaconic acid, methylenemalonic acid, citraconic acid, maleic anhydride, itaconic anhydride, and methylmalonic anhydride); esters of α,β-monoethylenically unsaturated mono- and dicarboxylic acids having 3 to 6 carbon atoms with alkanols having 1 to 12 carbon atoms (e.g., esters of acrylic acid, methacrylic acid, maleic acid, fumaric acid, or itaconic acid, with C1-C12, C1-C8, or C1-C4 alkanols such as ethyl, n-butyl, isobutyl and 2-ethylhexyl acrylates and methacrylates, dimethyl maleate and n-butyl maleate); acrylamides and alkyl-substituted acrylamides (e.g., (meth)acrylamide, N-tert-butylacrylamide, and N-methyl(meth)acrylamide); (meth)acrylonitrile; vinyl and vinylidene halides (e.g., vinyl chloride and vinylidene chloride); vinyl esters of C1-C18 mono- or dicarboxylic acids (e.g., vinyl acetate, vinyl propionate, vinyl n-butyrate, vinyl laurate and vinyl stearate); C1-C4 hydroxyalkyl esters of C3-C6 mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C1-C18 alcohols alkoxylated with from 2 to 50 mol of ethylene oxide, propylene oxide, butylene oxide or mixtures thereof (e.g., hydroxyethyl(meth)acrylate, hydroxypropyl(meth)acrylate, and methylpolyglycol acrylate); and monomers containing glycidyl groups (e.g., glycidyl methacrylate).

Additional monomers or co-monomers that can be used include linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-n-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate and sulfopropyl methacrylate); vinylphosphonic acid, dimethyl vinylphosphonate, and other phosphorus monomers; alkylaminoalkyl(meth)acrylates or alkylaminoalkyl(meth)acrylamides or quaternization products thereof (e.g., 2-(N,N-dimethylamino)ethyl(meth)acrylate, 3-(N,N-dimethylamino)propyl(meth)acrylate, 2-(N,N,N-trimethylammonium)ethyl(meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C1-C30 monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine).

The monomers used may include cross-linking monomers, such as divinylbenzene; 1,4-butanediol diacrylate; methacrylic acid anhydride; monomers containing 1,3-diketo groups (e.g., acetoacetoxyethyl(meth)acrylate or diacetonacrylamide); monomers containing urea groups (e.g., ureidoethyl(meth)acrylate, acrylamidoglycolic acid, and methacrylamidoglycolate methyl ether); and silane crosslinkers (e.g., 3-methacryloxypropyl trimethoxysilane and 3-mercaptopropyl trimethoxysilane). Additional examples of crosslinkers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glyoxal based crosslinkers; monomers containing two vinyl radicals; monomers containing two vinylidene radicals; and monomers containing two alkenyl radicals. Exemplary crosslinking monomers include diesters or triesters of dihydric and trihydric alcohols with α,β-monoethylenically unsaturated monocarboxylic acids (e.g., di(meth)acrylates, tri(meth)acrylates), of which in turn acrylic acid and methacrylic acid can be employed. Examples of such monomers containing two non-conjugated ethylenically unsaturated double bonds are alkylene glycol diacrylates and dimethacrylates, such as ethylene glycol diacrylate, 1,3-butylene glycol diacrylate, 1,4-butylene glycol diacrylate and propylene glycol diacrylate, vinyl methacrylate, vinyl acrylate, allyl methacrylate, allyl acrylate, diallyl maleate, diallyl fumarate and methylenebisacrylamide.

Functional groups present in the cross-linking monomers included in the binder described herein can be crosslinked by a chemical reagent. The chemical reagent is capable of crosslinking the functional groups of the cross-linking monomers to form, for example, covalent bonds, ionic bonds, hydrogen bonds, metallic bonds, dipole-dipole interactions, and cation-pi interactions.

Chemical reagents useful in the aqueous latex dispersions described herein include, for example, divalent and multivalent cations, such as zirconium (e.g., ammonium zirconium carbonate), zinc (e.g., zinc oxide and/or zinc peroxide), calcium, magnesium, aluminum, iron, tin, titanium, antimony, vanadium, and mixtures of these. Other suitable chemical reagents include carbodiimides (e.g., polycarbodiimides), polyisocyanates, organosilanes (e.g., epoxysilanes), urea-formaldehyde resins, melamine-formaldehyde resins, epoxy containing compounds, aziridines, acrylamides (e.g., N-methyloylacrylamide), hydrazides (e.g., adipic acid dihydrazide), glyoxal condensates, oxazolines, polyethylenimines, polyamines, dialdehydes, and mixtures of these.

The copolymer included in the binder can be prepared by heterophase polymerization techniques, including, for example, free-radical emulsion polymerization, suspension polymerization, and mini-emulsion polymerization. In some examples, the binders are prepared by polymerizing the monomers using free-radical emulsion polymerization. The emulsion polymerization temperature is generally from 10° C. to 95° C. or from 75° C. to 90° C. The polymerization medium can include water alone or a mixture of water and water-miscible liquids, such as methanol. In some embodiments, water is used alone. The emulsion polymerization can be carried out either as a batch, semi-batch, or continuous process. Typically, a semi-batch process is used. In some embodiments, a portion of the monomers can be heated to the polymerization temperature and partially polymerized, and the remainder of the polymerization batch can be subsequently fed to the polymerization zone continuously, in steps or with superposition of a concentration gradient.

The free-radical emulsion polymerization can be carried out in the presence of a free-radical polymerization initiator. The free-radical polymerization initiators that can be used in the process are all those which are capable of initiating a free-radical aqueous emulsion polymerization including alkali metal peroxydisulfates and H₂O₂, or azo compounds. Combined systems can also be used comprising at least one organic reducing agent and at least one peroxide and/or hydroperoxide, e.g., tert-butyl hydroperoxide and the sodium metal salt of hydroxymethanesulfinic acid or hydrogen peroxide and ascorbic acid. Combined systems can also be used additionally containing a small amount of a metal compound which is soluble in the polymerization medium and whose metallic component can exist in more than one oxidation state, e.g., ascorbic acid/iron(II) sulfate/hydrogen peroxide, where ascorbic acid can be replaced by the sodium metal salt of hydroxymethanesulfinic acid, sodium sulfite, sodium hydrogen sulfite or sodium metal bisulfite and hydrogen peroxide can be replaced by tert-butyl hydroperoxide or alkali metal peroxydisulfates and/or ammonium peroxydisulfates. In the combined systems, the carbohydrate derived compound can also be used as the reducing component. In general, the amount of free-radical initiator systems employed can be from 0.1 to 2%, based on the total amount of the monomers to be polymerized. In some embodiments, the initiators are ammonium and/or alkali metal peroxydisulfates (e.g., sodium persulfate), alone or as a constituent of combined systems. The manner in which the free-radical initiator system is added to the polymerization reactor during the free-radical aqueous emulsion polymerization is not critical. It can either all be introduced into the polymerization reactor at the beginning, or added continuously or stepwise as it is consumed during the free-radical aqueous emulsion polymerization. In detail, this depends in a manner known to an average person skilled in the art both from the chemical nature of the initiator system and on the polymerization temperature. In some embodiments, some is introduced at the beginning and the remainder is added to the polymerization zone as it is consumed. It is also possible to carry out the free-radical aqueous emulsion polymerization under superatmospheric or reduced pressure.

In addition, small amounts (e.g., from 0.01 to 2% by weight based on the total monomer weight) of molecular weight regulators, such as tert-dodecyl mercaptan, can optionally be used. Such substances are preferably added to the polymerization zone in a mixture with the monomers to be polymerized and are considered part of the total amount of unsaturated monomers used in the copolymer.

In some examples, the polymer for use in the binder has a glass transition temperature (T_{g}), as measured by differential scanning calorimetry, less than or equal to the temperature of the room in which the binder is used (e.g., in an attic, the T_{g} is 65° C. or less). For example, the T_{g} of the binder copolymer can be 50° C. or less, 40° C. or less, 30° C. or less, 20° C. or less, or 10° C. or less.

The polymers for use in the binder can include self-crosslinking polymers or crosslinkable polymers. Specific examples of useful polymers for inclusion in the binders described herein include, but are not limited to, ACRONAL OPTIVE 510, ACRONAL S 504, ACRONAL N 284, and ACRONAL NX 3587, acrylic polymers commercially available from BASF Corporation (Florham Park, N.J.). The polymers for use in the binder can also include flame retardant polymers.

The binders described herein can include adhesives or sealants. Examples of suitable adhesives include thermosetting adhesives, thermoplastic adhesives, elastomeric adhesives, and hybrid adhesives. The adhesives can be structural adhesives such as epoxies, epoxy hybrids, formaldehyde based adhesives (e.g., resorcinol formaldehyde, phenol resorcinol formaldehyde, melamine formaldehyde, and urea formaldehyde), phenolics and modified phenolics (nitrile-phenolics, vinyl-phenolics, and neoprene-phenolics), polyaromatic high temperature resins (e.g., polyimides, bismaleimides, and polybenzimidazoles), polyesters, polyurethanes, anaerobic resins, cyanoacrylates, and modified acrylics. Additionally, the adhesives can be non-structural adhesives such as elastomeric resins (e.g., natural rubber, asphalt, reclaimed rubber, butyl rubber, styrene butadiene rubber, polychloroprene, acrylonitrile butadiene, polyisobutylene, polyvinyl methyl ether, polysulfide, and silicone). The adhesives can also be thermoplastic resins, such as polyvinyl acetal, polyvinyl acetate, polyvinyl alcohol, thermoplastic elastomers, ethylene vinyl acetate, cellulosic resins, polyamide, polyester, polyolefins, polysulfone, phenoxy, and acrylic resins. Further, the adhesives can be naturally occurring resins such as natural organic resins (e.g., glues of agricultural or animal origin) or inorganic adhesives and cements (e.g., sodium silicate, phosphate cements, litharge cement, and sulfur cement).

Examples of suitable sealants include hardening and non-hardening sealants, two-part system sealants, single component sealants, and solvent and water release sealants. These sealants can be low performance sealants (e.g., oil- and resin-based sealants, asphaltic and other bituminous mastics, polyvinyl acetate, epoxy, and polyvinyl chloride plastisol), medium performance sealants (e.g., hydrocarbon rubber-based sealants, acrylic, chlorosulfonated polyethylene, and hot-melt sealants), or high performance sealants (e.g., fluorosilicone and fluoropolymer sealants, polysulfides, polyethers, polyurethanes, silicones, styrene butadiene copolymers, and chloroprenes). These and other suitable adhesives and sealants are described in detail in E. M. Petrie, “Handbook of Adhesives and Sealants, Chapter 8: Adhesive Classification, Chapter 10: Adhesive Families, Chapter 12: Sealant Classification and Composition, and Chapter 13: Sealant Families,” McGraw-Hill, New York, 2000.

In some embodiments, the binder is flame retardant by including one or more flame retardant additives or by being based on a flame retardant polymer. Examples of flame retardant additives or fillers suitable for inclusion in the binder include alumina trihydrate; hydrotalcite; synthetic or natural zeolites; alumina hydrates (e.g., alumina monohydrate); aluminum hydroxide; aluminum nitrate; ammonium polyphosphate; ammonium phosphate; ammonium alum; antimony oxide; decabromodiphenyloxide; potassium alum; kalimite; halogenated compounds (e.g., chlorinated waxes, brominated additives, plasticizers, and polyvinylchloride); inorganic hydroxides; barium chloride; barium peroxide; boric acid; borax; borate salts (e.g., zinc borate and calcium borate); calcium sulfate; calcium sulfite; calcium phosphate; magnesium pyrophosphate; magnesium ammonium chloride; magnesium carbonate; magnesium hydroxide; magnesium oxide; NOBLITE (Noble International; France); perlite; phosphate esters; sodium diboric phosphate; sodium tribasic phosphate; sodium meta silicate; sodium sulfate; sodium carbonate; vermiculite, zinc nitrate; hexabromocyclododecane; triallyl isocyanurate hexabromide; tetrachlorophenol; expandable graphite additives; pentaerythritols; phosphorus-based materials such as NCENDX P-30 and P-40 (commercially available from Albermarle Corporation; Baton Rouge, La.); and mixtures of these.

The binders described herein can have a solids percentage of 20% to 85%. For example, the binder can have a solids percentage from 30% to 80%, from 40% to 75%, or from 45% to 70%. The higher solids percentage and higher viscosity prevents the binder from soaking into existing surfaces such as existing insulation after it is applied. The binder also does not substantially compress underlying insulation. The binder can also be frothed, e.g., with air, when applied. When dried, the binder can be moisture vapor permeable. In some examples, the binder has a moisture vapor transmission rate of 5 to 50 perms or 10 to 20 perms (e.g., 13.5 perms) at a thickness of 16 mils. The binder can further include a tricyclic diterpene derivative and/or a crosslinking agent (e.g., a metal salt of an organic acid such as a zinc salt) as described in U.S. Patent Application Publication No. 2009/0199965, which is incorporated herein by reference in its entirety.

In some examples, the composition is substantially free of curing agents or crosslinking agents. “Substantially free” means that the composition can include less than 0.1%, less than 0.01%, less than 0.001%, less than 0.0001%, or 0% of curing agents or crosslinking agents based on the weight of the composition. In other examples, the binder contains reactive groups that can bond with one or more reactive groups present in the plurality of particles.

The compositions described herein can further include a filler. All or a portion of the filler can be flame retardant material as described herein, such as zinc borate and/or ammonium polyphosphate, to provide a flame retardant composition. Further examples of fillers suitable for use in the compositions described herein include ground/recycled glass (e.g., window or bottle glass), milled glass, glass spheres, glass flakes, glass fibers, clays (e.g., kaolin), feldspar, mica, talc, activated carbon, metals and alloys (e.g., nickel, copper, aluminum, silicon, solder, silver, and gold), metal-plated particulates (e.g., silver-plated copper, silver-plated nickel, and silver-plated glass microspheres), sol-gel ceramics (e.g., sol-gel SiO₂, TiO₂ or Al₂O₃), precipitated ceramics (such as SiO₂, TiO₂ or Al₂O₃), ceramic microspheres, fused silica, fumed silica, amorphous fused silica, aluminum trihydrate (ATH), sand, ground sand, slate dust, crusher fines, red mud, amorphous carbon (e.g., carbon black), wollastonite, alumina, bentonite, quartz, garnet, saponite, beidellite, granite, calcium carbonate, calcium oxide, calcium hydroxide, antimony trioxide, barium sulfate, magnesium oxide, titanium dioxide, zinc carbonate, zinc oxide, nepheline syenite, perlite, diatomite, pyrophillite, soda ash, trona, and organic or inorganic fibers. For example, the filler can include calcium carbonate and/or aluminum trihydrate. In some examples, the filler can include heat and/or infrared reflective materials, such as those present in RADIANCE e-0.25 AB-C, an acrylic copolymer emulsion/pigment blend commercially available from BASF Corporation (Florham Park, N.J.), and other pigments or metallic flake materials (e.g., aluminum flake materials). In some examples, the composition can include a liquid or solid flame retardant, for example, in an amount of 0 to 30% by weight of the composition. The composition can also include additives such as antioxidants, thickeners, fungicides, biocides, surfactants, defoamers, coalescing agents, tackifiers, plasticizers, dispersants, rheology modifiers, dyes, freeze-thaw agents, wetting agents, char formers, intumescents, other formulating agents, and mixtures thereof.

The composition, when dried, can provide insulating properties. For example, R values of the dried composition can range from 0.1 per inch to 6 per inch. When the composition includes a pre-expanded polymer as the plurality of particles, the R value of the dried composition can range from 1 per inch to 6 per inch (e.g., from 4 per inch to 6 per inch). The composition when dried can also be moisture vapor permeable (independent of the binder). In some embodiments, the composition has a moisture vapor transmission rate of 5 to 105 perms, 10 to 50 perms, or 15 to 35 perms at a thickness of 360 mils. The composition can be applied at a thickness of 100 to 10,000 mils, 200 to 4000 mils, or 400 to 1000 mils.

Methods of applying the composition onto a surface are also described herein. A first method includes combining a plurality of particles having a density of 1000 kg/m³ or less and a binder to form a composition wherein the plurality of particles comprise greater than 80% by volume of the composition and applying the composition onto a surface. In some examples, the composition can be pre-mixed in a container and then mechanically applied to the surface by using, for example, a hand tool such as a hand trowel. A second method of applying the compositions described herein onto a surface includes blowing a plurality of particles as described herein onto a surface in at least one first stream and a binder in at least one second stream. In some embodiments, the at least one second stream (including the binder) can be atomized. In some examples, there are multiple first streams (i.e., the plurality of particles is sprayed in more than one stream) and multiple second streams (i.e., the binder is sprayed in more than one stream). In some examples, the plurality of particles can be provided in a central stream with multiple (two or more) binder streams sprayed around the central stream and surrounding at least a portion of the central stream.

In some examples, a plurality of particles as described herein is included in the at least one first stream and the at least one second stream. In these embodiments, the plurality of particles is pre-coated with the binder in the at least one second stream and further combined with additional particles in the at least one first stream.

The one or more first streams containing the plurality of particles can be in contact with the one or more second streams containing the binder prior to reaching the surface. For example, the one or more first streams and the one or more second streams can be combined within an apparatus used for applying the composition onto the surface. Alternatively, the one or more first streams and the one or more second streams can combine to form a convergent stream after being sprayed from the apparatus. The surface can be a flat surface such as flooring or an attic space, or can be within a cavity or crevice. In some examples, the surface is an existing insulating layer (i.e., the composition is applied to an existing insulating layer).

The method of spraying the plurality of particles and the binder in separate streams allows the plurality of particles to be coated with the binder to allow bonding of the particles to one another. Alternatively, the plurality of particles and the binder can be pre-combined in an apparatus prior to spraying, thus allowing the plurality of particles to be coated with the binder prior to being applied, e.g., to a surface. The plurality of particles can be partially coated or fully coated with the binder and can be coated sufficiently to connect the particles together. The degree of binder coating can vary with the type and size of the plurality of particles. In some examples, from 5% to 100% of the surface of the plurality of particles is coated with binder. For example, from 15% to 90%, from 25% to 80%, or from 35% to 70% of the surface of the plurality of particles can be coated with the binder. When the binder coated plurality of particles (i.e., the composition) reach the surface, the composition can cure to form a continuous, bonded, moisture vapor permeable air barrier. The composition may cure at ambient temperature of the attic, which can range from −40° F. to 150° F. The composition may further cure, crosslink, or strengthen in the presence of, for example, a tricyclic diterpene derivative and/or a crosslinking agent as described above.

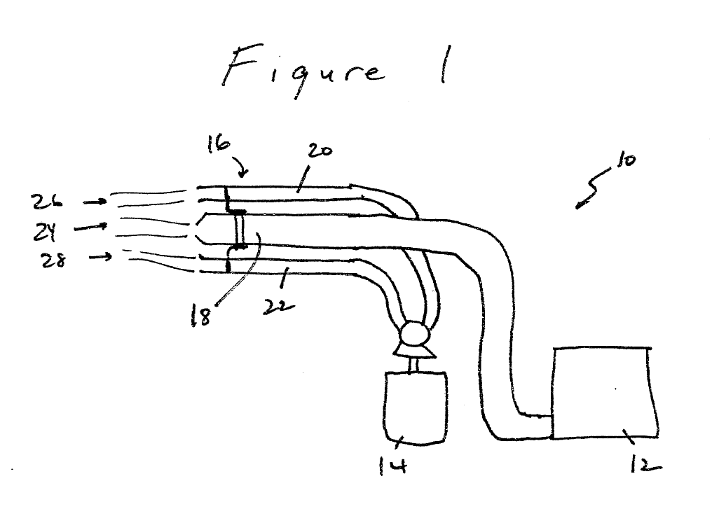

Further described herein is an apparatus 10 for spraying the composition described herein as shown in FIG. 1. The apparatus includes a first chamber 12 containing the plurality of particles, a second chamber 14 containing the binder, and a multicomponent nozzle 16 for applying the plurality of particles and the binder to a surface. For example, in FIG. 1, the multicomponent nozzle 16 can include a nozzle 18 for applying the plurality of particles and nozzles 20 and 22 for applying the binder to produce a stream 24 of particles and streams 26 and 28 of the binder. The apparatus can be adjusted for example through the use of valves such that the amount of the plurality of particles that exits the nozzle 18 can vary from 0% to 100% of the total composition and the amount of the binder that exits the nozzles 20 and 22 can vary from 0% to 100% of the total composition (by weight or by volume). For example, the apparatus can be adjusted to provide a composition containing 80% to 99.5% by volume of the plurality of particles (e.g., 94%) and 0.5 to 20% by volume of the binder (e.g., 6%). Alternately, a composition can be applied first including 100% plurality of particles to form a first layer followed by a composition including 100% of the binder as a thin layer bonding together the first layer of expanded polymer. In some examples, the second chamber 14 further comprises a plurality of particles as described herein. In some examples, the apparatus includes an air driven blower. The first and second chambers of the apparatus can also be air pumpable or pressurizable.

The compositions can be used as barriers in construction applications to minimize air flow and heat flow. The compositions can also be used as sound-deadening applications (e.g., in construction and automotive related applications) and as flooring (e.g., wood floors or carpet) underlayment. For example, the composition can be applied to a concrete subfloor and a floor covering (e.g., wood or vinyl) can be installed over the composition to provide sound-damping effects for the floor. In some examples, the compositions are moisture vapor permeable. The compositions can be applied and/or used, for example, under or over pre-existing insulation in residential or commercial building attics, crawl spaces, or walls. Examples of pre-existing insulation include fiberglass, cellulose, and rock wool (i.e., mineral wool) insulation. When applied over pre-existing insulation, the air barrier can prevent air migration or intrusion through the insulation and serve as a reinforcing layer for the insulation (e.g., the applied composition can enhance the R value of the pre-existing insulation). Further, due to the low weight of the plurality of particles, the composition can rest on top of surfaces (e.g., pre-existing insulation) without penetrating substantially into the surface. Examples of suitable surfaces include pre-existing insulation and other rigid or flexible surfaces. The composition can be applied to the surface in multiple layers with drying or curing in between each application. An additional protective coating (e.g., a heat reflective or absorbing coating) can further be applied to the composition upon drying. In some examples, the composition can further include a heat-reflective or heat barrier material (e.g., a pigment or a metallic filler) and acts as a dual-function composition, providing insulating and protecting properties to the surface (e.g., a roof deck). The additional protective coating can be applied to fully or partially cover the composition. The compositions can be applied onto sheathing material (e.g., polyethylene sheets, house wrap, or other suitable material), dried and/or cured (either pre-fabricated or prepared on-site), fashioned to a desired shape and/or size, and installed as part of a building or vehicular structure, including the attic, walls, or crawl space of a building.

The examples below are intended to further illustrate certain aspects of the methods and compounds described herein, and are not intended to limit the scope of the claims.

### EXAMPLES

### Example 1

### Binder Formulation

Exemplary ingredients for a binder formulation for use in the compositions as described herein are shown in Table 1.

TABLE 1

| Ingredients | Parts by weight of binder formulation |
|---|---|
| Polymer Latex | 5-95 |
| Filler | 5-95 |
| Flame Retardant Filler | 0-50 |
| Defoamer | 0.1-1.0 |
| Coalescing Agent | 0.1-1.0 |
| Adhesion Promoter/Wetting Agent | 0.1-1.0 |
| Surfactant/Dispersant | 0.1-2.0 |
| Water | 0-50 |
| Thickener | 0.1-2.0 |
| Biocide | 0.01-0.1 |

### Example 2

### Binder and Composition Formulation

A binder formulation was prepared by mixing the components provided in Table 2:

TABLE 2

| | Percentage by weight of |
|---|---|
| Ingredients | binder formulation |
| Styrene Acrylic Copolymer Latex (50% solids) | 49% |
| Filler Calcium Carbonate (Filler) | 21% |
| Zinc Borate (Flame Retardant Filler) | 14% |
| Defoamer | 0.3% |
| Coalescing Agent | 0.6% |
| Wetting Agent | 0.1% |
| Surfactant (Dispersant) | 0.7% |
| Water | 14% |
| Thickener | 0.2% |
| Biocide | 0.1% |

The binder formulation and pre-expanded polystyrene beads (i.e., the composition) were then applied to existing attic insulation using the apparatus illustrated in FIG. 1 in an amount of 6% by volume of the binder formulation and 94% by volume of flame retardant expanded polystyrene-based particles.

### Example 3

### Binder and Composition Formulation

A binder formulation can be prepared by mixing the components provided in Table 3:

TABLE 3

| | Percentage by weight of |
|---|---|
| Ingredients | binder formulation |
| Acrylic Copolymer Latex (53% solids) | 46.3% |
| Aluminum Trihydrate (ATH) | 30% |
| Zinc Borate | 5% |
| Defoamer | 0.3% |
| Coalescing Agent | 0.3% |
| Wetting Agent | 0.2% |
| Dispersant | 1% |
| Water | 16.55% |
| Thickener | 0.25% |
| Biocide | 0.1% |

The binder formulation and pre-expanded polystyrene beads (i.e., the composition) can then be applied to existing attic insulation using the apparatus illustrated in FIG. 1 in an amount of 5-10% by volume of the binder formulation and 90-95% by volume of flame retardant expanded polystyrene-based particles.

### Example 4

### Binder and Composition Formulation

A binder formulation can be prepared by mixing the components provided in Table 4:

TABLE 4

| | Percentage by weight of |
|---|---|
| Ingredients | binder formulation |
| Ethylene Vinyl Acetate Copolymer Latex | 49% |
| (50% solids) | |
| Aluminum Trihydrate (ATH) | 21% |
| Ammonium Polyphosphate | 14% |
| Defoamer | 0.3% |
| Coalescing Agent | 0.5% |
| Wetting Agent | 0.2% |
| Dispersant | 0.7% |
| Water | 14% |
| Thickener | 0.2% |
| Biocide | 0.1% |

The binder formulation and pre-expanded polystyrene beads (i.e., the composition) can then be applied to existing attic insulation using the apparatus illustrated in FIG. 1 in an amount of 5-10% by volume of the binder formulation and 90-95% by volume of NANOGEL aerogel particles.

The compositions, methods, and apparatuses of the appended claims are not limited in scope by the specific compositions, methods, and apparatuses described herein, which are intended as illustrations of a few aspects of the claims and any compositions, methods, and apparatuses that are functionally equivalent are intended to fall within the scope of the claims. Various modifications of the compositions, methods, and apparatuses in addition to those shown and described herein are intended to fall within the scope of the appended claims. Further, while only certain representative composition materials and method steps disclosed herein are specifically described, other combinations of the composition materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed.

What is claimed is:

1. A composition, comprising:
a plurality of particles having a density of 1000 kg/m³ or less; and
a binder,
wherein the plurality of particles comprise greater than 80% by volume of the composition.

2. The composition of claim 1, wherein the density of the plurality of particles is less than 300 kg/m³.

3. The composition of claim 1, wherein the density of the plurality of particles is less than 100 kg/m³.

4. The composition of claim 1, wherein the plurality of particles comprises greater than 85% by volume of the composition.

5. The composition of claim 1, wherein the plurality of particles includes pre-expanded polymers.

6. The composition of claim 5, wherein the pre-expanded polymer includes poly(styrene-co-acrylonitrile).

7. The composition of claim 1, wherein the plurality of particles includes inorganic particles.

8. The composition of claim 1, wherein the plurality of particles is flame retardant.

9. The composition of claim 1, wherein the plurality of particles includes recycled materials.

10. The composition of claim 1, wherein the plurality of particles includes insulating materials.

11. The composition of claim 1, wherein the binder when dried is moisture vapor permeable.

12. The composition of claim 1, wherein the binder comprises a self-crosslinking polymer or a crosslinkable polymer.

13. The composition of claim 12, wherein the binder further comprises a crosslinking agent.

14. The composition of claim 1, wherein the composition is substantially free of curing agents or crosslinking agents.

15. The composition of claim 1, wherein the binder is flame retardant.

16. The composition of claim 1, wherein the composition when dried has an R value of from 0.1 per inch to 6 per inch.

17. The composition of claim 1, further comprising a filler.

18. The composition of claim 17, wherein the filler is selected from the group consisting of zinc borate, alumina trihydrate, calcium carbonate, and mixtures thereof.

19. The composition of claim 17, wherein the filler includes a heat and/or infrared reflective material.

20. A method of applying a composition onto a surface, comprising: combining a plurality of particles having a density of 1000 kg/m³ or less and a binder to form a composition wherein the plurality of particles comprise greater than 80% by volume of the composition; and applying the composition onto a surface.

21. A method of applying a composition onto a surface, comprising blowing a plurality of particles having a density of 1000 kg/m³ or less in at least one first stream and spraying a binder in at least one second stream onto a surface.

22. The method of claim 21, wherein the binder is sprayed in more than one second stream onto the surface.

23. The method of claim 21, wherein the at least one first stream and the at least one second stream are combined outside of an apparatus for applying the composition onto a surface and prior to reaching the surface.

24. The method of claim 21, wherein the at least one first stream and the at least one second stream are combined within an apparatus for applying the composition onto a surface.

25. The method of claim 21, wherein the composition is applied to an existing insulating layer.

26. The method of claim 21, wherein the composition is applied into a cavity or crevice.

27. An apparatus for spraying a composition comprising a plurality of particles having a density of 1000 kg/m³ or less and a binder, comprising:
a first chamber comprising the plurality of particles;
a second chamber comprising the binder; and
a multicomponent nozzle for applying the plurality of particles and the binder to a surface;
wherein the apparatus is adjustable such that the amount of the plurality of particles that exits the nozzle can vary from 0% to 100% of the total composition and the amount of the binder that exits the nozzle can vary from 0% to 100% of the total composition.
